(19) United States
(12) Patent Application Publication
(10) Pub. No.: US 2017/0072855 A1
(43) Pub. Date: Mar. 16, 2017

(54) REARVIEW VIDEO FULL WINDSHIELD PROJECTOR

(71) Applicant: Panasonic Automotive Systems Company of America, Division of Panasonic Corporation of North America, Peachtree City, GA (US)

(72) Inventor: PADMANABAN KANAGARAJ, FARMINGTON HILLS, MI (US)

(73) Assignee: Panasonic Automotive Systems Company of America, Division of Panasonic Corporation of North America

(21) Appl. No.: 15/261,526

(22) Filed: Sep. 9, 2016

Related U.S. Application Data
(60) Provisional application No. 62/217,579, filed on Sep. 11, 2015.

(51) Int. Cl. B60R 1/00

(52) U.S. Cl. CPC B60R 1/00; B60R 2300/205; B60R 2300/8066

(57) ABSTRACT

A vehicle includes a rear view camera, a windshield, an image projector associated with the windshield, a sensor detecting when the vehicle is in a reverse gear, and an electronic processor communicatively coupled to each of the rear view camera, the image projector and the sensor. The electronic processor causes the image projector to project images captured by the rear view camera onto the windshield in response to the sensor detecting that the vehicle is in a reverse gear.

### CROSS-REFERENCED TO RELATED APPLICATIONS

This application claims benefit of U.S. Provisional Application No. 62/217,579 filed on Sep. 11, 2015, which the disclosure of which is hereby incorporated by reference in its entirety for all purposes.

### FIELD OF THE INVENTION

The disclosure relates to the field of automotive displays, and, more particularly, to an apparatus for viewing in a rearward direction from a motor vehicle.

### BACKGROUND OF THE INVENTION

A driver must normally turn his head around to look out the rear window while backing up, which is awkward and requires the driver to use a steering wheel that is in front of the driver, and thus in the opposite direction from the rearward direction in which he is looking. Alternatively, the user can use rearview mirrors when backing up, but rearview mirrors provide only a small image, making it difficult for the driver to see objects that are behind the vehicle. More recently, a rearwardly directed camera on the vehicle may capture video that is displayed on a center stack display when the vehicle is in reverse. However, the center stack display is typically small, making it difficult for the driver to see all objects behind the vehicle and judge distances.

### SUMMARY

The present invention may capture rearview images by use of a camera, and project the images onto the windshield so that the driver may view a large rearview image while looking in a forward direction. Thus, the driver may be enabled to drive the vehicle in the reverse direction while looking forward, and may therefore drive backwards more safely and faster.

In one embodiment, the invention comprises a vehicle including a rear view camera, a windshield, an image projector associated with the windshield, a sensor detecting when the vehicle is in a reverse gear, and an electronic processor communicatively coupled to each of the rear view camera, the image projector and the sensor. The electronic processor causes the image projector to project images captured by the rear view camera onto the windshield in response to the sensor detecting that the vehicle is in a reverse gear.

In another embodiment, the invention comprises a display method for a motor vehicle. It is detected when the motor vehicle is in a reverse gear. Video images of a space behind the motor vehicle are captured. In response to the detecting that the vehicle is in a reverse gear, the captured video images are projected onto a windshield of the motor vehicle.

In yet another embodiment, the invention includes a vehicle having a rear view camera, a front view camera, a windshield, a rear window, a first image projector associated with the windshield, a second image projector associated with the rear window, and an electronic processor communicatively coupled to each of the rear view camera, the front view camera, the first image projector and the second image projector. The processor receives a signal indicating that the vehicle is in a reverse gear, and, in response to receiving the signal, causes the first image projector to project images captured by the rear view camera onto the windshield, and causes the second image projector to project images captured by the front view camera onto the rear window.

The invention may have the advantage that the driver may better and more easily see and view in a rearward direction, and may more easily steer the vehicle while looking in the rearward direction.

The invention may solve the problem of the driver not getting a full view of the road in a rear view.

The invention may enable a driver to drive smoothly in a rearward direction without having to turn his head.

### BRIEF DESCRIPTION OF THE DRAWINGS

A better understanding of the present invention will be had upon reference to the following description in conjunction with the accompanying drawings.

FIG. 1 is a plan view of an example projection of a rearview image on a windshield of a vehicle according to the present invention.

FIG. 2a is a rear view of a motor vehicle of the invention including a rearview camera.

FIG. 2b is a front view of a motor vehicle of the invention including a frontview camera.

FIG. 3 is a block diagram of one embodiment of a rearview video full windshield projector arrangement of the present invention.

FIG. 4 is a flow chart of one embodiment of a display method of the present invention for a motor vehicle.

### DETAILED DESCRIPTION OF THE PREFERRED EMBODIMENTS

FIG. 1 illustrates one embodiment of an example projection of a rearview image on a windshield of a vehicle according to the present invention. As shown in FIG. 1, the entire road rearview may be projected onto the front windshield. Also, the left and right rear seat side views may be projected onto the front seat right and left windows. Consistent with the rear view being projected onto the front windshield, the view through the rear right side window may be projected onto the front left side window; and the view through the rear left side window may be projected onto the front right side window.

A display technology such as head up display (HUD) or full windshield head up display (FW-HUD) technology may be used to project the rear views and/or rear view video captured by one or more cameras onto the front windshield and front side windows in real time.

In one embodiment, front view video and/or images may be captured by one or more cameras and may be displayed on the center stack display of the vehicle. Views of 180°, 270° or 360°, for example, along the horizon may be captured and projected onto the windows and windshield of the vehicle. Further, the images and video may be inversed when projected such that the driver may turn the steering wheel counterclockwise in order to turn left relative to a rearward view, and may turn the steering wheel clockwise in order to turn right relative to a rearward view. For example, the view through the rear right side window may be projected onto the front left side window; and the view through the rear left side window may be projected onto the front right side window. Thus, inversion of the rearward images and video may enable the driver to turn the steering wheel in the direction that his intuition tells him to when viewing the rearward view on his windshield.

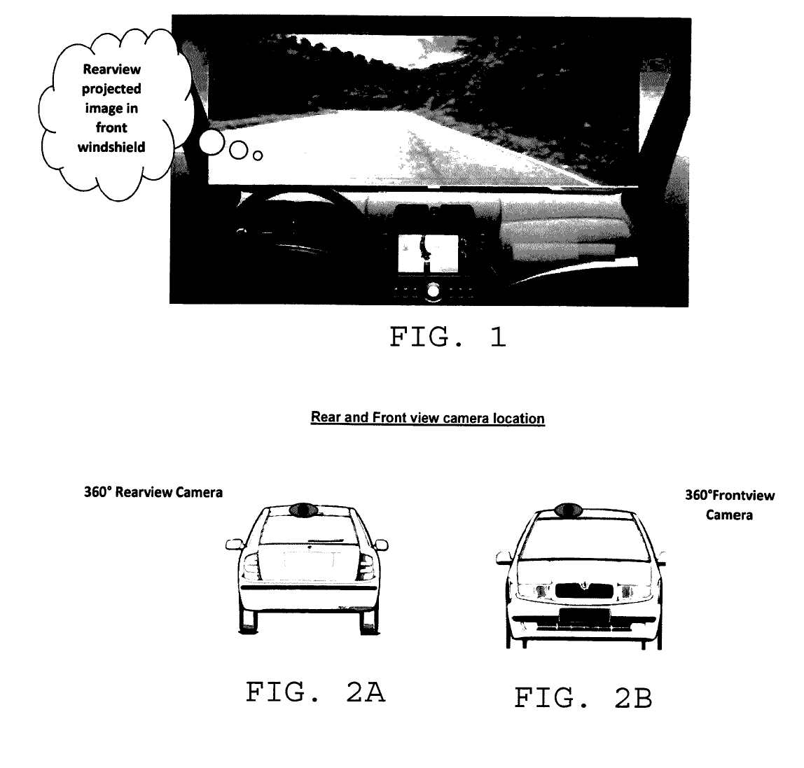

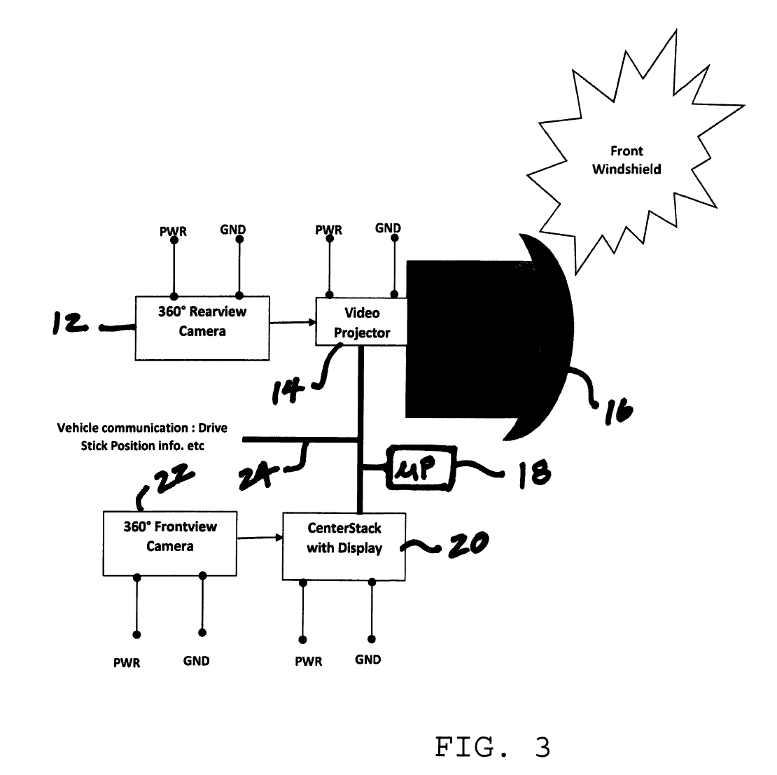

FIG. 2a illustrates a motor vehicle of the invention including a rear view camera mounted at the top of the rear window. The camera may be directed in a horizontal rearward direction that is parallel to the road when the motor vehicle is traveling straight along the road.

FIG. 2b illustrates the motor vehicle including a front view camera mounted at the top of the windshield when the motor vehicle is traveling straight along the road. The camera may be directed in a horizontal forward direction that is parallel to the road. The front view camera may be directed in a direction that is opposite to the direction in which the rear view camera is directed. Either or both the rear view camera and the front view camera may be a fisheye camera with a 180 degree or hemispherical field of view. Thus, the two cameras together may have a 360 degree or spherical field of view.

FIG. 3 is a block diagram of one embodiment of a rearview video full windshield projector arrangement 10 of the present invention including a rear view camera 12, a video projector 14, a front windshield 16, an electronic processor 18, a center stack display 20, and a front view camera 22. Video projector 14, processor 18, and center stack display 20 are communicatively coupled through a vehicle communication bus 24. Processor 18 may also be communicatively coupled through vehicle communication bus 24 to a PRNDL shift lever or “drive stick” (not shown).

During use, processor 18 may detect, via communication bus 24, when the PRNDL shift lever is in the reverse (“R”) position. In response to detecting that PRNDL shift lever is in the reverse position, processor 18 may cause the images and/or video captured by rear view camera 12 to be projected onto windshield 16 by projector 14, and may cause the images and/or video captured by front view camera 22 to be presented on center stack display 20.

In response to detecting that PRNDL shift lever is in any other position than reverse, processor 18 may cease the projection of images and/or video onto windshield 16, and may no longer cause the images and/or video captured by front view camera 22 to be presented on center stack display 20. Thus, the driver may again view in a forward direction through the windshield, and the center stack display may again present textual or graphic images, for example.

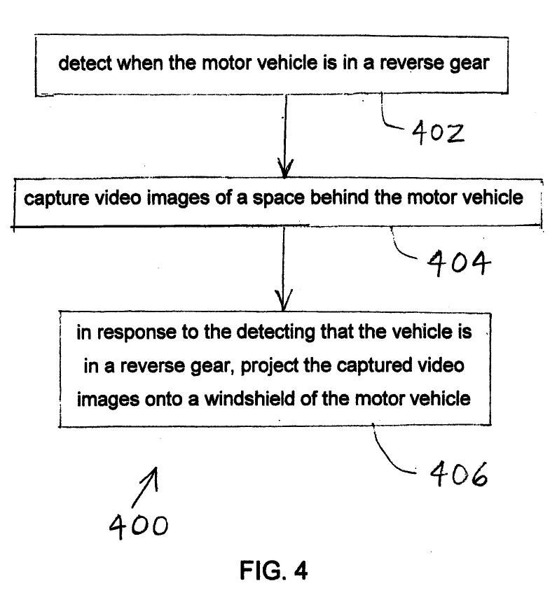

FIG. 4 illustrates one embodiment of a display method 400 of the present invention for a motor vehicle. In a first step 402, it is detected when the motor vehicle is in a reverse gear. That is, the PRNDL of the motor vehicle in communicatively coupled to an electronic processor, which senses when the PRNDL is in the reverse gear.

Next, in step 404, video images of a space behind the motor vehicle are captured. For example, rearview camera 12 may capture images of the environment in the rearward direction, which is opposite to the forward direction in which the driver of the vehicle typically faces.

In a last step 406, in response to the detecting that the vehicle is in a reverse gear, the captured video images are projected onto a windshield of the motor vehicle. For example, in response to detecting that the PRNDL is in “R”, the images captured by camera 12 may be projected onto front windshield 16, as shown in FIG. 1.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a rear view camera;
a windshield;
an image projector associated with the windshield;
a sensor configured to detect when the vehicle is in a reverse gear; and
an electronic processor communicatively coupled to each of the rear view camera, the image projector and the sensor, the processor being configured to cause the image projector to project images captured by the rear view camera onto the windshield in response to the sensor detecting that the vehicle is in a reverse gear.

2. The vehicle of claim 1 wherein the processor is configured to cause the image projector to project images captured by the rear view camera onto substantially an entirety of the windshield.

3. The vehicle of claim 1 wherein the image projector comprises a head up display.

4. The vehicle of claim 1 wherein the processor is configured to cause the image projector to project an inverse of images captured by the rear view camera onto the windshield.

5. The vehicle of claim 1 wherein the rear view camera has a field of view of approximately between 150 degrees and 180 degrees.

6. The vehicle of claim 5 wherein portions of the images captured by the rear view camera are projected onto side windows of the vehicle.

7. The vehicle of claim 1 wherein the image projector comprises a first image projector, the vehicle further comprising:
a front view camera communicatively coupled to the electronic processor;
a rear window; and
a second image projector associated with the rear window and communicatively coupled to the electronic processor, wherein the processor is configured to cause the second image projector to project images captured by the front view camera onto the rear window in response to the sensor detecting that the vehicle is in the reverse gear.

8. A display method for a motor vehicle, the method comprising:
detecting when the motor vehicle is in a reverse gear;
capturing video images of a space behind the motor vehicle; and
in response to the detecting that the vehicle is in a reverse gear, projecting the captured video images onto a windshield of the motor vehicle.

9. The method of claim 8 wherein the images captured by the rear view camera are projected onto substantially an entirety of the windshield.

10. The method of claim 8 wherein the image projector comprises a head up display.

11. The method of claim 8 wherein an inverse of the captured video images is projected onto the windshield.

12. The method of claim 8 wherein the video images are captured by a rear view camera having a field of view of approximately between 150 degrees and 180 degrees.

13. The method of claim 12 further comprising projecting portions of the images captured by the rear view camera onto side windows of the vehicle.

14. The method of claim 8, further comprising:
capturing video images of a space in front of the motor vehicle; and
in response to the detecting that the vehicle is in the reverse gear, projecting the captured video images of the space in front of the motor vehicle onto a rear window of the motor vehicle.

15. The method of claim 14 wherein an inverse of the captured video images of the space in front of the motor vehicle are projected onto the rear window.

16. A vehicle, comprising:
a rear view camera;
a front view camera;
a windshield;
a rear window;
a first image projector associated with the windshield;
a second image projector associated with the rear window; and
an electronic processor communicatively coupled to each of the rear view camera, the front view camera, the first image projector and the second image projector, the processor being configured to receive a signal indicating that the vehicle is in a reverse gear, and, in response to receiving the signal, cause the first image projector to project images captured by the rear view camera onto the windshield, and cause the second image projector to project images captured by the front view camera onto the rear window.

17. The vehicle of claim 16 wherein the processor is configured to cause the first image projector to project images captured by the rear view camera onto substantially an entirety of the windshield, and to cause the second image projector to project images captured by the front view camera onto substantially an entirety of the rear window.

18. The vehicle of claim 16 wherein the processor is configured to cause the image projector to project an inverse of images captured by the rear view camera onto the windshield.

19. The vehicle of claim 16 wherein the rear view camera has a field of view of approximately 180 degrees and the front view camera has a field of view of approximately 180 degrees such that the rear view camera and the front view camera conjunctively have a 360 degree field of view.

20. The vehicle of claim 19 wherein portions of the images captured by the rear view camera are projected onto front side windows of the vehicle, and portions of the images captured by the front view camera are projected onto rear side windows of the vehicle.
